(19) United States
(12) Patent Application Publication
(10) Pub. No.: US 2026/0259089 A1
(43) Pub. Date: Sep. 3, 2026

(54) CAPACITANCE SENSOR

(71) Applicants: HONDA MOTOR CO., LTD., Tokyo (JP); The University of British Columbia, Vancouver (CA)

(72) Inventors: Ryusuke Ishizaki, Wako-shi (JP); Takeshi Osato, Wako-shi (JP); Sadan Wani, Vancouver (CA); Chrysanthemum Morton, Vancouver (CA); John D W Madden, Vancouver (CA); Ying Li, Vancouver (CA); Reese Critchlow, Vancouver (CA)

(21) Appl. No.: 19/550,399

(22) Filed: Feb. 26, 2026

(30) Foreign Application Priority Data
Feb. 28, 2025 (JP) 2025-032265

(51) Int. Cl. G01L 1/14

(52) U.S. Cl. CPC G01L 1/146

(57) ABSTRACT

A capacitance sensor includes: a first electrode; a flexible member having a dielectric property and elasticity; and a second electrode provided in the flexible member to face the first electrode with a space between the second electrode and the first electrode and configured to detect a capacitance between the second electrode and the first electrode. The flexible member includes: an electrode inclusion portion including the second electrode in the electrode inclusion portion and separated from the first electrode; a plurality of pillar portions extending between the electrode inclusion portion and the second electrode; and a filled portion filled with a dielectric material containing a bubble in a gap.

### CROSS-REFERENCE TO RELATED APPLICATION

Priority is claimed on Japanese Patent Application No. 2025-032265, filed Feb. 28, 2025, the contents of which are incorporated herein by reference.

### BACKGROUND

### Field of the Invention

The present invention relates to a capacitance sensor.

### Background

In realizing a tactile sensor for a robot, it is required to detect a force of contact with an external system from a minute force to a large force while maintaining flexibility of a surface thereof. Accordingly, a capacitance type tactile sensor including a flexible electrode and a dielectric with a pillar structure has been proposed (Japanese Unexamined Patent Application, First Publication No. 2024-086155 and Japanese Unexamined Patent Application, First Publication No. 2024-086156).

In the related art, a technique described in PCT International Publication No. WO 2020/066121 and a technique described in Japanese Unexamined Patent Application, First Publication No. 2021-018692 are known.

### SUMMARY

However, a fingertip tactile sensor of a robot hand performing a dexterous operation needs to detect a force distribution with a high density in addition to a minute force. In this case, a supposed inter-electrode pitch is ⅓ times that in the related art, and an electrode size is about ¼ times that in the related art. When an electrode area decreases, a capacitance decreases and data cannot be acquired by a controller, or an S/N ratio decreases even when data can be acquired. Accordingly, it is difficult to realize a capacitance sensor with flexibility, high sensitivity, and a high density.

There is room for improvement in the related art.

An objective of an aspect of the present invention is to provide a capacitance sensor that can maintain flexibility and extend a detection range.

According to a first aspect of the present invention, a capacitance sensor is provided including: a first electrode; a flexible member having a dielectric property and elasticity; and a second electrode provided in the flexible member to face the first electrode with a space between the second electrode and the first electrode and configured to detect a capacitance between the second electrode and the first electrode, wherein the flexible member includes: an electrode inclusion portion including the second electrode in the electrode inclusion portion and separated from the first electrode; a plurality of pillar portions extending between the electrode inclusion portion and the second electrode; and a filled portion filled with a dielectric material containing a bubble in a gap between the pillar portions.

A second aspect is the capacitance sensor according to the first aspect, wherein a high dielectric layer formed of a material with a higher dielectric constant than that of the flexible member can be provided between the first electrode and the second electrode.

A third aspect is the capacitance sensor according to the second aspect, wherein the filled portion can be formed of a material with a higher dielectric constant than that of the flexible member.

According to the first aspect, since the filled portion formed of a material with a higher dielectric constant than that of the flexible member is provided between the first electrode disposed along a board surface and the second electrode separated from the first electrode, it is possible to direct more electric field emitted from one electrode to the other electrode in comparison with a case in which the filled portion is not provided. Accordingly, it is possible to enhance the dielectric constant between the first electrode and the second electrode in comparison with a case in which the filled portion is not provided.

Accordingly, it is possible to increase a capacitance formed between the first electrode and the second electrode, to increase a change in capacitance at the time of application of a minute force even when an electrode size is small, and to extend a range of a detectable force.

The first electrode may be disposed on a surface of a board or may be formed in the flexible member along the surface of the board.

According to the second aspect, since the high dielectric layer formed of a material with a higher dielectric constant than that of the flexible member is provided between the first electrode and the second electrode in addition to the filled portion, it is possible to direct more electric field emitted from one electrode to the other electrode in comparison with a case in which the high dielectric layer is not provided. Accordingly, it is possible to enhance the dielectric constant between the first electrode and the second electrode in comparison with a case in which the high dielectric layer is not provided. As a result, it is possible to increase the capacitance formed between the first electrode and the second electrode, to increase a change in capacitance at the time of application of a minute force even when an electrode size is small, and to extend a range of a detectable force.

According to the third aspect, since the dielectric constant of a space formed between the pillar portions was originally based on air but the filled portion with a higher dielectric constant than that of air is located between the first electrode and the second electrode, it is possible to enhance the dielectric constant between the first electrode and the second electrode. Accordingly, it is possible to direct more electric field emitted from one electrode to the other electrode in comparison with a case in which the filled portion is not provided. As a result, in comparison with a case in which the filled portion is not provided, it is possible to increase the capacitance formed between the first electrode and the second electrode, to increase a change in capacitance at the time of application of a minute force even when an electrode size is small and to extend a range of a detectable force.

According to the aspects of the present invention, it is possible to provide an advantage capable of extending a detectable force range by increasing a change in capacitance at the time of application of a minute force even when an electrode size is small.

### BRIEF DESCRIPTION OF THE DRAWINGS

FIG. 1 is a sectional view schematically illustrating a capacitance sensor according to a first embodiment of the present invention.

FIG. 2 is a sectional view schematically illustrating dimensions of a capacitance sensor according to the related art.

FIG. 3 is a sectional view schematically illustrating an electric field in a capacitance sensor according to a second embodiment of the present invention.

### DESCRIPTION OF EMBODIMENTS

Hereinafter, a capacitance sensor according to a first embodiment of the present invention will be described with reference to the accompanying drawings.

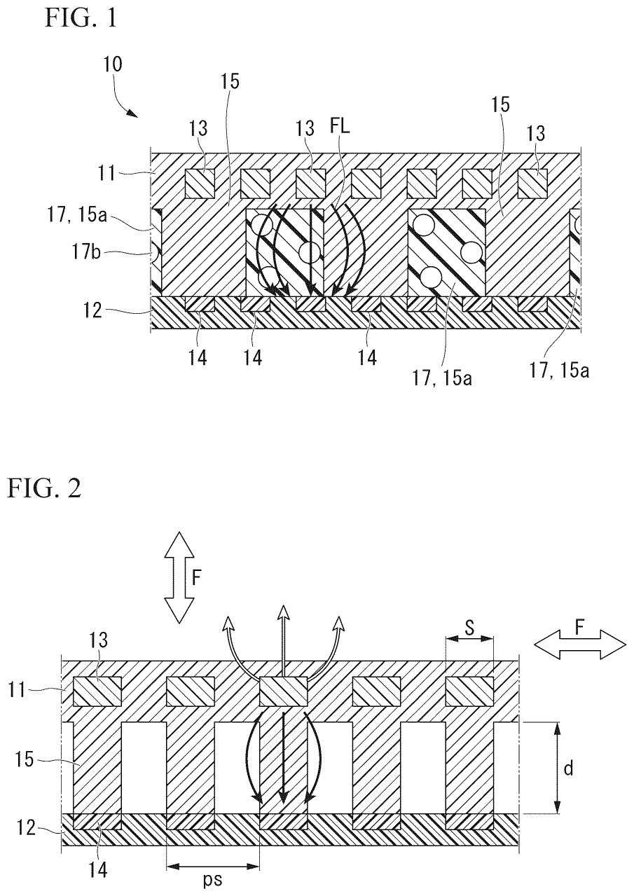

FIG. 1 is a sectional view schematically illustrating a capacitance sensor according to the present embodiment. In the drawing, reference sign 10 denotes a capacitance sensor.

As illustrated in FIG. 1, the capacitance sensor 10 according to the present embodiment includes an electrode inclusion portion 11, a board 12, a transmission electrode (a second electrode) 13, a reception electrode (a first electrode) 14, a pillar (a pillar portion) 15, and a foamed portion (a filled portion) 17.

The electrode inclusion portion 11 is disposed along a surface of the board 12. The electrode inclusion portion 11 is disposed to face the board 12. The electrode inclusion portion 11 is disposed to be substantially parallel to the surface of the board 12. The electrode inclusion portion 11 is separated from the surface of the board 12. The electrode inclusion portion 11 includes a plurality of transmission electrodes 13.

The board 12 has a plate shape. The board 12 may have a planar shape or a curved shape. The board 12 may be formed of a material which is harder than a flexible member 15A which will be described later. The board 12 may be a printed board or the like. The board 12 may be formed of a flexible member 15A which will be described later. In the board 12, a plurality of reception electrodes 14 are disposed along the surface.

A plurality of transmission electrodes 13 are disposed substantially on the same plane. The plurality of transmission electrodes 13 are located in the same layer. The same layer means that the plurality of transmission electrodes 13 are disposed at substantially the same distance from the surface of the board 12. The plurality of transmission electrodes 13 are separated from each other. The plurality of transmission electrodes 13 have substantially the same contour shape. The plurality of transmission electrodes 13 have the same area. In a plan view, a separation distance between the neighboring transmission electrodes 13 is constant.

The transmission electrodes 13 face the reception electrodes 14. The transmission electrodes 13 correspond to the reception electrodes 14. In a plan view, the transmission electrodes 13 are disposed to overlap the corresponding reception electrodes 14.

A plurality of reception electrodes 14 are disposed along the surface of the board 12. The plurality of reception electrodes 14 are disposed substantially on the same plane. The plurality of reception electrodes 14 are located in the same layer. The plurality of reception electrodes 14 are separated from each other. The plurality of reception electrodes 14 have substantially the same contour shape. The plurality of reception electrodes 14 have substantially the same area. In a plan view, a separation distance between the neighboring reception electrodes 14 is constant. In a plan view, the separation distance between the neighboring reception electrodes 14 is equal to the separation distance between the neighboring transmission electrodes 13.

Wire portions which are not illustrated are connected to the transmission electrodes 13 and the reception electrodes 14 and are connected to a control unit which is not illustrated. The control unit can detect a capacitance between the transmission electrodes 13 and the reception electrodes 14.

The pillar 15 connects the electrode inclusion portion 11 and the board 12 in a stacking direction. A plurality of pillars 15 are formed on the surface of the board 12. The plurality of pillars 15 are separated from each other. The plurality of pillars 15 have substantially the same sectional contour shape in a plan view. The plurality of pillars 15 have substantially the same area. The plurality of pillars 15 have almost the same sectional shape in the whole length in an axial direction parallel to the direction in which they are separated from the surface of the board 12. In a plan view, separation distances between the neighboring pillars 15 are the same.

The sectional contour shape of the pillar 15 in a plan view may be the same as the contour shape of the transmission electrode 13. The sectional contour shape of the pillar 15 in a plan view may be larger than the contour shape of the transmission electrode 13.

In a plan view, the separation distance between the neighboring pillars 15 may be equal to the separation distance between the neighboring transmission electrodes 13. In a plan view, the separation distance between the neighboring pillars 15 may be larger than the separation distance between the neighboring transmission electrodes 13. In a plan view, the separation distance between the neighboring pillars 15 may be smaller than the separation distance between the neighboring transmission electrodes 13.

A wire portion which is not illustrated may be formed in the pillar 15.

The electrode inclusion portion 11 and the pillar 15 are formed of a dielectric or a flexible elastomer which can be elastically deformed. The electrode inclusion portion 11 and the pillar 15 are formed of the flexible member 15A which is the same material. The electrode inclusion portion 11 and the pillar 15 are formed as a unified body. The pillar 15 can be bonded to the board 12 by an adhesive layer (not illustrated) which is the same material as the flexible member 15A.

Alternatively, an electrode built-in layer formed of the flexible member 15A and including the reception electrode 14 may be formed on the surface of the board 12.

The board 12 may be formed of the flexible member 15A.

The flexible member 15A is formed of, for example, silicone rubber, polyvinylchloride (PVC) gel, or a flexible dielectric including polyvinylidene fluoride (PVDF), polydimethylsiloxane (PDMS), a silicon-based resin, a urethane resin, an epoxy-based resin, a styrene-based resin, or a composite material thereof. For example, a material with a dielectric constant of about 2=1.4 F/m can be selected for the flexible member 15A. The flexible member 15A may have material characteristics indicating hyperelasticity, flexibility, elasticity, and a material containing gas which is a material having a fluid or bubbles.

All of the transmission electrode 13 and the reception electrode 14 are formed of a conductor having stretchability. The transmission electrode 13 and the reception electrode 14 can be formed of a material in which an additive for changing the conductivity or the dielectric constant is added to the same flexible member 15A as that of the electrode inclusion portion 11 and the pillar 15. The wires connected to the transmission electrode 13 and the reception electrode 14 can also be formed of the same material. The transmission electrode 13 and the reception electrode 14 may be formed, for example, by mixing conductive powder into the flexible member 15A. The transmission electrode 13 and the reception electrode 14 may be formed of a silicon-based resin with a conductor mixed thereinto such as carbon, carbon nano fiber, or graphite, a silicon-based resin containing metallic conductive fillers such as silver or copper, a conductive resin such as a thiophene-based conductive polymer or polystyrene sulfonate (PSS), or a composite material thereof.

A plurality of pillars 15 may be provided upright between the electrode inclusion portion 11 and the board 12. Gaps 15a are formed between the plurality of pillars 15.

The gaps 15a are filled with a foamed portion 17.

The foamed portion 17 is formed of a high dielectric material containing bubbles 17b. The foamed portion 17 is more flexible than the pillar 15 because bubbles 17b are contained therein. The foamed portion 17 has sufficient flexibility and thus does not interfere with elastic deformation of the pillars 15.

The foamed portion 17 may be formed to have a high dielectric constant by mixing a high dielectric material such as graphite, titanium oxide (TiO₂), or barium titanate (BaTiO₃) into the flexible member 15A. The size and a density of the bubbles 17b in the foamed portion 17 can be set on the basis of whether a shape of a sensor can be maintained, that is, an amount of mixed-in bubbles can be set to a range in which a flexible material is curable.

The dielectric constant ε in the foamed portion 17 is exemplified below.
Graphite (ε=12 to 13)
TiO₂ (ε=80 to 180)
BaTiO₃ (ε=1000 to 5000)

In the capacitance sensor 10 according to the present embodiment, in a state in which an external load F is not applied, an area in which the transmission electrode 13 and the reception electrode 14 overlap in a plan view is S.

In the state in which an external load Fis not applied, a distance between the transmission electrode 13 and the reception electrode 14 is d. When a capacitance between the transmission electrode 13 and the reception electrode 14 in the state in which an external load F is not applied is C, the capacitance C is expressed by the following expression.

C=ε·S/d

When an external load F is applied, the electrode inclusion portion 11 and the pillar 15 are deformed. The pillar 15 is deformed to correspond to the direction of the external load F.

When the external load F is applied in a direction in which the transmission electrode 13 and the reception electrode 14 are compressed, the inter-electrode distance d between the transmission electrode 13 and the reception electrode 14 changes. Alternatively, when the external load F is applied in a direction in which the transmission electrode 13 and the reception electrode 14 are separated from each other, the inter-electrode distance d between the transmission electrode 13 and the reception electrode 14 changes similarly.

In this case, the capacitance C between the transmission electrode 13 and the reception electrode 14 changes. By detecting this change in capacitance, it is possible to measure the external load F.

Alternatively, when an external load F is applied in a direction parallel to the board 12, the transmission electrode 13 is shifted with respect to the reception electrode 14, and the area S in which the transmission electrode 13 overlaps the reception electrode 14 changes to an area S−Δ. Then, the capacitance C between transmission electrode 13 and the reception electrode 14 changes. By detecting this change in capacitance, it is possible to measure the external load F.

An external load F may be applied in an oblique direction in addition to the normal direction of the surface of the board 12 and the direction parallel to the surface of the board 12. In this case, the change of the inter-electrode distance d and the change of the overlapping area S occur at the same time. Then, the capacitance between the transmission electrode 13 and the reception electrode 14 changes similarly. By detecting this change in capacitance, it is possible to measure the external load F.

FIG. 2 is a sectional view schematically illustrating dimensions in the capacitance sensor.

As electrode sizes in a capacitance sensor according to the related art, a pitch p between the same type of electrodes is about 4 mm, and an electrode size S is about 2 mm square. On the other hand, as electrode sizes in the capacitance sensor 10 according to the present embodiment, a pitch p between the transmission electrodes 13 is about 1.5 mm, and the size S of the transmission electrode 13 is about 2 mm square, or about 1 mm square or φ1 mm.

When the electrode size is decreased as in the capacitance sensor 10 according to the present embodiment, the number of electric lines of force FL directed from the transmission electrode 13 to the reception electrode 14 decreases as illustrated in FIG. 2. When the electrode size is decreased, the capacitance C between the transmission electrode 13 and the reception electrode 14 in a pair decreases in comparison with the size of the electrode in the related art. Then, the sensor sensitivity deteriorates, and the magnitude of a detectable external load increases. That is, a small force cannot be detected.

However, in the capacitance sensor 10 according to the present embodiment, the foamed portion 17 formed of a high dielectric material is disposed between the transmission electrode 13 and the reception electrode 14. Accordingly, the dielectric constant ε between the transmission electrode 13 and the reception electrode 14 increases.

It can be seen from the expression for the capacitance C that the capacitance C also increases as the dielectric constant ε increases. Accordingly, as illustrated in FIG. 1, it is possible to increase the number of electric lines of force FL directed from the transmission electrode 13 to the reception electrode 14. As a result, it is possible to improve sensitivity to a change of the capacitance C and to decrease the magnitude of a detectable external load. That is, it is possible to detect a small force. That is, it is possible to improve the sensitivity which is sensor characteristics.

Specifically, the capacitance sensor 10 according to the present embodiment can detect a force of contact with an external system, that is, from a minute force of about 0.02 N to a large force of about 1 N as an external load F.

When the capacitance sensor 10 according to the present embodiment is manufactured, a board 12 in which the reception electrodes 14 are formed is prepared. An electrode inclusion portion 11 including the transmission electrodes 13 is formed. At this time, after a plate body formed of the flexible member 15A including recessed parts corresponding to the transmission electrodes 13 has been shaped using a mold, the transmission electrodes 13 can be formed using the flexible member 15A in which conductive particles are mixed into the recessed parts of the plate body. Alternatively, the transmission electrodes 13 having predetermined shapes are first formed at predetermined positions, and then the electrode inclusion portion 11 may be formed as a unified body to cover the transmission electrodes 13.

Then, the pillars 15 are formed as a unified body with the electrode inclusion portion 11 including the transmission electrodes 13 using a mold corresponding to the pillars 15.

Subsequently, a foamed portion 17 is formed between a plurality of pillars 15 using a flexible member 15A into which high-dielectric particles are mixed. In this case, the foamed portion 17 can be cured after application, filling, or impressing has been performed thereon.

In order to form necessary bubbles 17b, a foaming agent or a bubble former can be added to the foamed portion 17 before filling is performed. A chemical foaming agent, a physical foaming agent, or foaming beads can be used as the foaming agent. An agent obtained by forming soluble particles such as sugar in a predetermined shape and then dissolving the soluble particles through water washing to form voids can be used as the bubble former.

Ends of the pillars 15 are connected to the board 12 to manufacture the capacitance sensor 10.

Alternatively, after the ends of the pillars 15 are connected to the board 12, the gaps 15a formed between the electrode inclusion portion 11 and the board 12 may be filled with the foamed portion 17.

In the capacitance sensor 10 according to the present embodiment, the transmission electrodes 13 and the reception electrodes 14 with an electrode pitch of about 1.5 mm and an electrode size of about 1 mm square or φ1 mm are arranged in a high density such that they can easily change a relative position therebetween using the flexible pillars 15 and the foamed portion 17. Accordingly, it is possible to decrease the capacitance C between the electrodes in each pair and to detect a distribution of a minute external load F without damaging the S/N ratio. As a result, for example, it is possible to provide a capacitance sensor with a minute and fine sensor sensitivity which can be applied to a region corresponding to a fingertip, not a region corresponding to a palm, as a tactile sensor for a robot. Specifically, it is possible to detect a force in a range from about 0.02 N to about 1 N.

A capacitance sensor according to a second embodiment of the present invention will be described below with reference to the drawing.

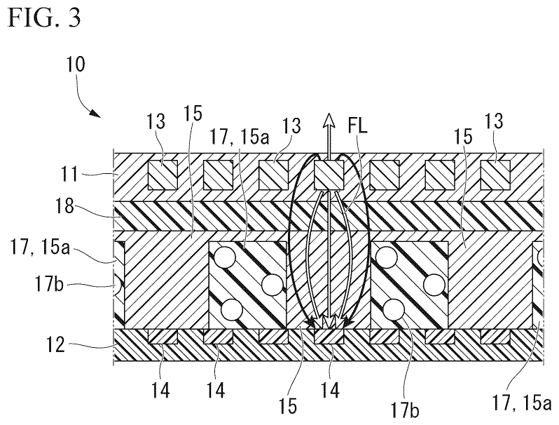

FIG. 3 is a sectional view schematically illustrating the capacitance sensor according to the present embodiment. The present embodiment is different from the first embodiment in a high dielectric layer. The other constituents corresponding to those in the first embodiment will be referred to by the same reference signs, and description thereof will be omitted.

A capacitance sensor 10 according to the present embodiment includes an interlayer portion (a high dielectric layer) 18 as illustrated in FIG. 3.

The interlayer portion 18 is provided in the electrode inclusion portion 11. The interlayer portion 18 is provided at a position which is closer to the transmission electrode 13 than to the reception electrode 14. The interlayer portion 18 is provided at a position which is closer to the transmission electrode 13 than to the pillar 15.

The interlayer portion 18 increases the number of electric lines of force FL directed from the transmission electrode 13 to the reception electrode 14. The interlayer portion 18 directs as many electric fields as possible from the transmission electrode 13 to the reception electrode 14. Accordingly, the interlayer portion 18 is preferably as close to the transmission electrode 13 as possible. The interlayer portion 18 may be in contact with the transmission electrode 13.

The interlayer portion 18 is disposed to overlap all the transmission electrodes 13 in a plan view. The interlayer portion 18 is disposed in a region including all the outermost transmission electrodes 13 in a plan view. The interlayer portion 18 is formed in the same range as a region obtained by connecting the contours of the outermost transmission electrodes 13 in a plan view. The interlayer portion 18 may be formed in a larger range than the region obtained by connecting the contours of the outermost transmission electrodes 13 in a plan view. The interlayer portion 18 may be formed on the whole surface of the electrode inclusion portion 11 in a plan view.

Accordingly, the interlayer portion 18 increases the number of electric lines of force FL directed from the transmission electrode 13 to the reception electrode 14. Particularly, the electric lines of force directed from a side position of the transmission electrode 13 to the reception electrode 14 as a so-called fringe are directed to the corresponding reception electrode 14. Accordingly, the interlayer portion 18 is formed of a material with a high dielectric constant.

Similarly to the foamed portion 17, the interlayer portion 18 may be formed to have a high dielectric constant by mixing graphite, titanium oxide (TiO₂), or barium titanate (BaTiO₃) to the flexible member 15A. The interlayer portion 18 does not include bubbles unlike the foamed portion 17.

The interlayer portion 18 can have flexibility equivalent to the electrode inclusion portion 11.

The thickness of the interlayer portion 18 is uniform as a whole in a plan view. When the thickness of the interlayer portion 18 increases, the inter-electrode distance d increases, and thus the thickness is preferably as small as possible. The thickness of the interlayer portion 18 can be set such that the capacitance C between the transmission electrode 13 and the reception electrode 14 is the same value in a case in which the interlayer portion 18 is provided and the gap 15a is not filled with the foamed portion 17 and a case in which the interlayer portion 18 is not provided and the gap 15a is filled with the foamed portion 17.

In manufacturing the capacitance sensor 10 according to the present embodiment, since the interlayer portion 18 is located in a layer different from the transmission electrodes 13, the interlayer portion 18 can be formed by adding a step of stacking a material of the interlayer portion 18 at the time of formation of the electrode inclusion portion 11.

In the capacitance sensor 10 according to the present embodiment, the interlayer portion 18 formed of a high dielectric material in addition to the foamed portion 17 is disposed between the transmission electrode 13 and the reception electrode 14. Accordingly, in comparison with the first embodiment, it is possible to further increase the dielectric constant ε between the transmission electrode 13 and the reception electrode 14. As a result, it is possible to improve the sensitive to a change of the capacitance C and to decrease the magnitude of a detectable external load. That is, it is possible to detect a small force. That is, it is possible to improve sensitivity which is sensor characteristics. It is possible to realize a capacitance sensor with flexibility, high sensitivity, and a high density.

The present invention can also be realized by individually selecting and combining the configurations of the aforementioned embodiments.

Particularly, the capacitance sensor 10 according to the present invention can employ a configuration in which the interlayer portion 18 is provided and the gap 15a is not filled with the foamed portion 17.

Relations between structural differences and sensor characteristics in such configurations will be described below.

TABLE 1

| | | | | Interlayer |
|---|---|---|---|---|
| | | | | portion + |
| | | Interlayer | Foamed | foamed |
| Structure | Related art | portion | portion | portion |
| Feature | Low/middle | High | High | High density, |
| | density | density, | density, | high |
| | | flexible | thin | sensitivity |
| Density | Middle | High | High | High |
| Sensitivity | X | ◯ | ◯ | ⊙ |
| (small electrode | | | | |
| size, low | | | | |
| application region) | | | | |
| Total thinness | ◯ | Δ | ◯ | Δ |
| Flexibility | ◯ | ◯ | Δ | Δ |
| (middle/high | | | | |
| application region) | | | | |
| Number of wires | ◯ | Δ | Δ | Δ |
| Manufacturing | ⊙ | ◯ | Δ | Δ |
| easiness | | | | |

In Table 1, in the structure according to the related art, the pitch p between the same type of electrodes is about 4 mm, and the electrode size S is about 2 mm square. In all of the structure of interlayer portion, the structure of foamed portion, and the structure of interlayer portion+foamed portion, the pitch p between the transmission electrodes 13 is about 1.5 mm, and the electrode size S of the transmission electrode 13 is about 2 mm square or about 1 mm square or φ1 mm.

In the structure of interlayer portion, the interlayer portion 18 is provided, and the gap 15a is not filled with the foamed portion 17.

In the structure of foamed portion, similarly to the first embodiment, the gap 15a is filled with the foamed portion 17, and the interlayer portion 18 is not provided. In the structure of interlayer portion+foamed portion, similarly to the second embodiment, the gap 15a is filled with the foamed portion 17, and the interlayer portion 18 is provided.

In the structure according to the related art, the feature of low/middle density, it corresponds to the number of electrodes per unit area in which the pitch p between the same type of electrodes is about 4 mm, and the electrode size S is about 2 mm square. In the structure of interlayer portion, the feature of high density and flexible corresponds to the number of electrodes per unit area in which the pitch p between the transmission electrodes 13 is about 1.5 mm, and the electrode size S of the transmission electrode 13 is about 2 mm square or about 1 mm square or φ1 mm. This means that flexibility associated with deformation between the transmission electrode 13 and the reception electrode 14 is not affected because the foamed portion 17 is not provided and is based on flexibility of only the pillars 15.

In the structure of foamed portion, the feature of high density and thin corresponds to the number of electrodes per unit area in which the pitch p between the transmission electrodes 13 is about 1.5 mm, and the electrode size S of the transmission electrode 13 is about 2 mm square or about 1 mm square or φ1 mm. This means that there is no thickness of the interlayer portion 18, and thus the distance between the transmission electrode 13 and the reception electrode 14 is based on flexibility of only the pillars 15.

In the structure of interlayer portion+foamed portion, the feature of high density and high sensitivity corresponds to the number of electrodes per unit area in which the pitch p between the transmission electrodes 13 is about 1.5 mm, and the electrode size S of the transmission electrode 13 is about 2 mm square or about 1 mm square or φ1 mm. This means that the interlayer portion 18 and the foamed portion 17 are provided, and thus improvement of the dielectric constant is caused in both portions.

In the structure of interlayer portion, the structure of foamed portion, and the structure of interlayer portion+foamed portion, “high” density corresponds to the number of electrodes per unit area in which the pitch p between the transmission electrodes 13 is about 1.5 mm, and the electrode size S of the transmission electrode 13 is about 2 mm square or about 1 mm square or φ1 mm.

In the structure according to the related art, the density corresponds to the number of electrodes per unit area in which the pitch p between the same type of electrodes is about 4 mm, and the electrode size S is about 2 mm square.

The sensitivity of X in the structure according to the related art and the sensitivity of O in the structure of interlayer portion and the structure of foamed portion mean that, since the electrode size is small, it is possible to detect a minute external load and to detect a distribution of a minute external load along a sensor surface.

In the structure of interlayer portion+foamed portion, the sensitivity of means that, since the electrode size is small and a high dielectric member is disposed between the electrodes to increase the capacitance, it is possible to detect a more minute external load and to detect a distribution of a more minute external load.

In the structure according to the related art and the structure of foamed portion, the total thinness of O means that there is no increase in the sensor thickness due to the interlayer portion 18.

In the structure of interlayer portion and the structure of interlayer portion+foamed portion, the total thinness of A means that there is an increase in the sensor thickness due to the interlayer portion 18.

In the structure according to the related art and the structure of interlayer portion, the flexibility of O means that the gap 15a is not filled with the foamed portion 17 and sensor deformation for detecting an external load is based on only the pillars 15.

In the structure of foamed portion and the structure of interlayer portion+foamed portion, the flexibility of A means that deformation of the pillar 15 for detecting an external load is affected by the foamed portion 17 filled in the gap 15a.

The number of wires of O in the structure according to the related art and the number of wires of Δ in the structure of interlayer portion, the structure of foamed portion, and the structure of interlayer portion+foamed portion mean that it is necessary to increase or decrease the number of wires according to the number of electrodes.

In the structure according to the related art, the manufacturing easiness of ⊙ means that, since the electrode size is large, manufacturing is easy.

In the structure of interlayer portion, the manufacturing easiness of O is because, since the electrode size is small, required accuracy increases.

In the structure of foamed portion and the structure of interlayer portion+foamed portion, the manufacturing easiness of A is because required accuracy increases because the electrode size is small and the number of steps increases because filling and foaming steps are necessary after the pillars 15 have been shaped in manufacturing of the foamed portion 17.

What is claimed is:

1. A capacitance sensor comprising:
a first electrode;
a flexible member having a dielectric property and elasticity; and
a second electrode provided in the flexible member to face the first electrode with a space between the second electrode and the first electrode and configured to detect a capacitance between the second electrode and the first electrode,
wherein the flexible member includes:
an electrode inclusion portion including the second electrode in the electrode inclusion portion and separated from the first electrode;
a plurality of pillar portions extending between the electrode inclusion portion and the second electrode; and
a filled portion filled with a dielectric material containing a bubble in a gap between the pillar portions.

2. The capacitance sensor according to claim 1,
wherein a high dielectric layer formed of a material with a higher dielectric constant than that of the flexible member is provided between the first electrode and the second electrode.

3. The capacitance sensor according to claim 1,
wherein the filled portion is formed of a material with a higher dielectric constant than that of the flexible member.
